(19) United States
(12) Patent Application Publication
(10) Pub. No.: US 2009/0053609 A1
(43) Pub. Date: Feb. 26, 2009

(54) NON-AQUEOUS ELECTROLYTE BATTERY

(75) Inventors: Hiroshi MINAMI, Moriguchi-shi (JP); Takeshi OGASAWARA, Moriguchi-shi (JP); Naoki IMACHI, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/194,840

(22) Filed: Aug. 20, 2008

(30) Foreign Application Priority Data
Aug. 22, 2007 (JP) 2007-215647
May 22, 2008 (JP) 2008-133791

(51) Int. Cl. H01M 4/62

(52) U.S. Cl. 429/232

(57) ABSTRACT

In a non-aqueous electrolyte battery including: a positive electrode; a negative electrode; a separator located between the positive and negative electrodes; a non-aqueous electrolyte; and an inorganic particle layer being located on the surface of at least one of the positive and negative electrodes, the inorganic particle layer contains inorganic particles and a binder, the inorganic particles include spherical or substantially spherical inorganic particles and non-spherical inorganic particles.

### BACKGROUND OF THE INVENTION

1. Field of the Invention

The present invention relates to improvements regarding non-aqueous electrolyte batteries, such as lithium-ion batteries or polymer batteries, and particularly to a battery structure that enables the battery to exhibit excellent high-temperature cycle characteristics and operate with high reliability even if a high-capacity battery design is adopted.

2. Description of Related Art

In recent years, the rapid reductions in size and weight of mobile phones, notebook computers, personal digital assistants (PDAs) and other mobile information devices have created a demand for batteries with higher capacities as the power sources for those devices. One such battery is the lithium-ion battery, in which the charge-discharge reactions take place with lithium ions shuttling between the positive and negative electrodes. Due to its high energy-density and high capacity, the lithium-ion battery is generally used as a power source for various mobile information devices as listed earlier.

Recent mobile information devices show a tendency to consume more power due to the expansion and sophistication of their functions, such as showing movies or playing games. Accordingly, there is a strong demand for their power sources, i.e. the lithium-ion battery, to have higher capacities and better performance that provides longer playing time, higher output power and so on.

With such a background, the conventional efforts in the research and development of lithium-ion batteries with higher capacities have been primarily devoted to thinning the components that are not involved in the power generation, such as the battery can, separator, and current collectors (an aluminum or copper foil) of the positive and negative electrodes (for example, refer to Japanese Unexamined Patent Application Publication No. 2002-141042), or filling more active materials (i.e. improving the filling density of the electrodes). However, measures such as these are approaching their limitations, and other essential improvements, such as employing novel materials, are required for increasing the battery capacity. One possible solution is to find new active materials for the positive and negative electrodes. For example, alloys of silicon (Si), tin (Sn) or other elements are promising as the negative electrode active material. However, for the positive electrode active material, lithium cobalt oxide is currently the only practical choice; no other materials practically used can exceed it in capacity and simultaneously compare with (or even exceed) it in performance.

In such a situation, the inventors have developed, and put on the market, a battery using cobalt lithium oxide as the positive electrode active material, whose capacity can be increased by enhancing the use depth (or charge depth) by raising the charge cut-off voltage from the current level (4.2 V) to higher levels. The reason why the capacity can be enhanced by increasing the use depth of the battery is because 4.2 V batteries (i.e. batteries with a charge cut-off voltage of 4.2 V) normally use no higher than approximately 160 mAh/g out of the theoretical capacity (approx. 273 mAh/g) of lithium cobalt oxide; raising the charge cut-off voltage to 4.4 V increases the usable capacity to approximately 200 mAh/g.

The biggest challenge against the use of lithium cobalt oxide at higher voltages is that the positive electrode active material, when charged, becomes more oxidative, which not only accelerates the decomposition of the electrolyte but also destabilizes the crystal structure of the positive electrode active material when lithium is extracted from it, causing a cycle deterioration or storage deterioration of the battery due to a collapse of the crystal.

As explained previously, it has been found that increasing the charge cut-off voltage of a battery destabilizes the crystal structure of the positive electrode and deteriorates the battery performance, particularly at high temperatures. Although the detailed reason for this phenomenon is unknown, the result of an analysis suggests that the presence of decomposition products of the electrolyte and the dissolution of elements from the positive electrode active material (e.g. the dissolution of cobalt if lithium cobalt oxide is used) are the prime factors for the deterioration of cycle characteristics or storage characteristics at high temperatures.

The high-temperature storage is particularly problematic for battery types using lithium cobalt oxide, lithium manganate, lithium cobalt-nickel-manganese composite oxide or the like in the positive electrode active material. Storing these batteries at high temperatures causes cobalt or manganese to be ionized and dissolved from the positive electrode. The dissolved elements will be reduced at the negative electrode and deposited onto the electrode or separator, causing problems such as an increase in the internal resistance of the battery and a decrease in the battery capacity due to the increased internal resistance. These problems become more pronounced if the charge cut-off voltage of the lithium-ion battery is increased, since this operation destabilizes the crystal structure as explained earlier. The result is that these unfavorable phenomena tend to be strongly observed even at low temperatures around 50° C., at which there was no problem for the conventional 4.2V battery type.

For example, a storage test of a 4.4 V battery with lithium cobalt oxide as the positive electrode active material and graphite as the negative electrode active material (testing conditions: the charge cut-off voltage, 4.4 V; the storage temperature, 60° C.; and the storage period, five days) has demonstrated that the battery's remaining capacity drastically decreases after storage, which may be approximately zero in some cases. Thus, a positive electrode active material that is structurally unstable in the charged state tends to more severely suffer from the storage deterioration and cycle deterioration, particularly at high temperatures. This is most likely because the elements (e.g. cobalt or manganese) dissolved from the positive electrode active material and the decomposition products of the electrolyte move from the positive electrode to the negative electrode and are then decomposed by reduction at the negative electrode, to form a deposition layer on the negative electrode active material, and this layer prevents the intercalation of lithium into the negative electrode.

To cope with this problem, the inventors have proposed an electrode with an inorganic particle layer formed thereon. This layer traps the elements dissolved from the positive electrode active material or the decomposition products of the electrolyte, thereby preventing these elements or products from directly depositing onto the negative electrode active material. The inorganic particle layer also helps the electrolyte to be supplied to the electrode, thus preventing the shortage of electrolyte at a specific portion of the electrode (particularly, at the central portion). These actions of the inorganic particle layer (i.e. trapping the dissolved elements or decomposition products, and helping the supply of electrolyte) have been proved to be effective in improving both the high-temperature storage characteristics and high-temperature cycle characteristics of the battery. However, there is room for further improvements since the aforementioned actions in some cases are insufficient.

Thus, an objective of the present invention is to provide a non-aqueous electrolyte battery that has excellent high-temperature storage characteristics and high-temperature cycle characteristics and can operate with high reliability even if a high-capacity battery design is adopted.

### BRIEF SUMMARY OF THE INVENTION

To achieve this objective, the present invention provides a non-aqueous electrolyte battery including: a positive electrode; a negative electrode; a separator located between the positive and negative electrodes; a non-aqueous electrolyte; and an inorganic particle layer being located on the surface of at least one of the positive and negative electrodes, the inorganic particle layer containing inorganic particles and a binder, wherein the inorganic particles include spherical or substantially spherical inorganic particles and non-spherical inorganic particles.

### DETAILED DESCRIPTION OF THE INVENTION

Experiments conducted by the inventors have demonstrated that, in the case where only spherical or substantially spherical inorganic particles are used, the particles inside the inorganic particle layer are densely packed, leaving almost no void in between, so that the layer can effectively trap the elements dissolved from the positive electrode active material or the decomposition products of the electrolyte. However, the inorganic particle layer with almost no void left inside impedes the permeation of the electrolyte and thereby causes a shortage of the electrolyte in the positive or negative electrode. This situation causes a decrease in capacity and uneven chemical reactions at the electrode, resulting in a deterioration of the cycle characteristics and other properties.

On the other hand, in the case where only non-spherical inorganic particles are used as the inorganic particles, the particles inside the inorganic particle layer are not densely packed; there are plenty of voids left inside. Accordingly, the electrolyte can smoothly permeate and be adequately supplied into the positive or negative electrode. However, presence of too much of a void inside the inorganic particle layer reduces the effect of trapping the dissolved elements or decomposition products, and eventually deteriorates the storage characteristics and cycle characteristics at high temperatures. Furthermore, the exclusive use of non-spherical inorganic particles as the inorganic particles deteriorates the dispersion capability of a slurry prepared for creating the inorganic particle layer, so that there will be particles agglomerated and bubbles formed in the slurry. The agglomerated particles and bubbles unfavorably affect the resultant inorganic particle layer since the layer is as thin as a few micrometers. The use of a slurry with such a poor dispersion capability lowers the coating quality. (For example, segregation of a highly-insulating binder occurs or the coating thickness becomes non-uniform, so that it is difficult to obtain a layer with uniform qualities.) The result is that the chemical reactions cannot uniformly take place at the electrode, which further deteriorates the cycle characteristics.

A possible reason for the low dispersion capability of the slurry resulting from the use of non-spherical inorganic particles is because the process of dispersing fine particles generally applies a shearing force to the particles; this force pulverizes non-spherical (particularly, atypical) particles more easily than spherical ones, and the particles thus pulverized attract each other by gravitation into agglomerated forms.

In contrast to the preceding cases, the present invention uses a mixture of spherical or substantially spherical inorganic particles and non-spherical inorganic particles in the inorganic particle layer. Due to the presence of the spherical or substantially spherical inorganic particles, the proportion of the void inside the inorganic particle layer becomes smaller than in the case where only non-spherical inorganic particles are used, so that the layer can adequately exhibit the effect of trapping the dissolved elements or decomposition products. The presence of the spherical or substantially spherical inorganic particles also makes the dispersion capability of the slurry higher than in the case where only non-spherical inorganic particles are used. As a result, unfavorable situations such as the segregation of a highly-insulating binder or an uneven thickness of the coating can be prevented, so that the chemical reactions can uniformly take place at the electrode. Furthermore, the presence of the non-spherical inorganic particles provides more of a void inside the inorganic particle layer than in the case where only the spherical or substantially spherical inorganic particles are used, so that the electrolyte can more smoothly permeate and be adequately supplied into the positive or negative electrode. These favorable effects significantly improve the storage characteristics and cycle characteristics at high temperatures.

The “substantially spherical inorganic particle” does not need to be exactly spherical but may be in any shape as long as its actions and effects are equivalent to those of a spherical inorganic particle. For example, it may be a somewhat spherical particle with minor irregularities on its surface or with a slightly elliptical section. A primary or secondary particle can also provide sufficient effects if it is somewhat spherical.

It is preferable that the inorganic particle layer be located on the surface of the negative electrode.

If the inorganic particle layer is formed on the surface of the positive electrode, it is impossible to completely trap the elements dissolved from the positive electrode active material or the decomposition products of the electrolyte, and a portion of these elements or products will be involved in the reactions at the negative electrode and deposited on it. The materials thus deposited will impede the supply of the electrolyte and thereby deteriorate the storage characteristics and cycle characteristics at high temperatures. On the other hand, if the inorganic particle layer is formed on the surface of the negative electrode, the dissolved elements or decomposition products coming from the positive electrode will be trapped on the surface of the inorganic particles and cannot directly deposit onto the negative electrode. Accordingly, the electrolyte can be assuredly supplied to the electrode, so that the storage characteristics and cycle characteristics at high temperatures will be prevented from deteriorating. Forming the inorganic particle layer on the negative electrode is also preferable because the negative electrode needs a greater supply of electrolytes than the positive electrode. The negative electrode is easier to run short of electrolytes since its active material experiences a larger magnitude of expansion and shrinkage than that of the positive electrode during the charge and discharge process.

It is preferable that the non-spherical inorganic particles have at least one shape selected from the group consisting of rod-like shapes, scaly shapes, atypical shapes, fibrous shapes and polygonal shapes.

Selection of one or more of these shapes will strengthen the effects obtained by the addition of the non-spherical inorganic particles. However, the shape of the non-spherical inorganic particles is not limited to the aforementioned group; they may be in any shape other than the spherical or substantially spherical shapes. The minimal requirement is that the non-spherical inorganic particles should have at least one shape selected from the rod-like, scaly, atypical, fibrous and polygonal shapes; they may naturally have two or more different shapes selected from this group.

It is preferable that the shape of the non-spherical inorganic particles be atypical.

The selection of atypical particles as the non-spherical inorganic particles further strengthens the effects obtained by the addition of the non-spherical inorganic particles. The atypical particles also have an advantage over the other particles, such as rod-shaped or scaly ones, in that atypical particles are easier to be processed into fine particles having an average particle size of 1 μm or less. The use of fine inorganic particles having an average particle size of 1 μm or less preferably enables the formation of a thin inorganic particle layer. Larger particles will unfavorably make this layer thicker, causing a decrease in the amounts of the positive electrode active material and negative electrode active material, which are intended to directly contribute to the power generation of the battery.

In addition, the average particle size in the present specification is a value measured by the laser diffraction method.

It is preferable that the proportion of the atypical particles to the total amount of the inorganic particles be 25 mass % or greater and 99 mass % or less, and specifically 40 mass % or greater and 75% or less.

If the proportion of the atypical particles is too low, the void ratio in the inorganic particle layer will be too low and the permeability of the electrolyte will deteriorate, which may lower the cycle characteristics. On the other hand, if the proportion of the atypical particles is too high, the void ratio in the inorganic particle layer will be too high to ensure an adequate trapping effect, which may results in an insufficient improvement in the high-temperature storage characteristics. Furthermore, too high a proportion of the atypical inorganic particles will deteriorate the dispersion capability of the slurry and the coating quality. This may impede uniform chemical reactions at the electrode and resultantly deteriorate the battery characteristics, such as the high-temperature cycle characteristics.

It is preferable that the inorganic particles be made of rutile-type titania or alumina.

The reason for this limitation on the inorganic particles to rutile-type titania or alumina is because these substances are highly stable (i.e. not reactive with lithium) inside the battery and yet available at low costs. The reason for the structural limitation on titania to the rutile structure is that titania with the anatase structure is capable of intercalation and de-intercalation of lithium ions and can absorb lithium and exhibit electron conductivity, depending on the ambient atmosphere or potential, in which case the battery may possibly lose its capacity or cause short-circuiting. Titania with a rutile structure is also advantageous in that it is highly dispersible in a slurry and hence enables the creation of an inorganic particle layer with uniform qualities.

However, since the kind of inorganic particles has only a minor impact on the effects of the present invention, it is possible to use other kinds of inorganic particles, such as zirconia or magnesia.

The average particle size of the inorganic particles may be preferably 1 μm or less in order to prevent the inorganic particle layer from being too thick. Treating the surface of the inorganic particles with aluminum, silicon or titan is especially preferable to improve the dispersion capability of the slurry.

It is preferable that the atypical inorganic particles be made of alumina and the spherical inorganic particles be made of titania.

The reason for these limitations is because alumina is easy to process into atypical particles by sintering and can be easily controlled so that its average particle size will be 1 μm or less, while titania is popularly used in the ink industry and its products with a particle size of 1 μm or less are available at low costs.

It is preferable that the proportion of the binder to the inorganic particles be 30 mass % or less, specifically 10 mass % or less, and more preferably 5 mass % or less.

The reason for the upper limit of the binder concentration relative to that of the inorganic particles is because too high a binder concentration drastically lowers the permeability of lithium ions into the active material layer (i.e. impedes the supply of the electrolyte), which increases the resistance between the two electrodes and thereby causes a decrease in the charge-discharge capacity. However, the proportion of the binder to the inorganic particles should be preferably 1 mass % or greater since the binding strength of the particles within the inorganic particle layer decreases if the proportion of the binder to the inorganic particles becomes lower than 1 mass %.

It is preferable that the average particle size of the inorganic particles be larger than the average pore size of the separator.

The purpose of this limitation is to avoid the following problems. If the average particle size of the inorganic particles is smaller than the average pore size of the separator, the inorganic particles may pass through a portion of the separator and severely damage the separator during the winding and pressing processes of the battery production. Furthermore, the inorganic particles can intrude into the small pores of the separator and deteriorate various characteristics of the battery.

It is preferable that the positive electrode be charged to a level of 4.30 V or higher relative to the potential of a lithium reference electrode if the positive electrode active material at the positive electrode has a layer structure, or a level of 4.20 V or higher relative to the potential of a lithium reference electrode if the positive electrode active material at the positive electrode has a spinel structure.

The provision of the inorganic particle layer will be significantly advantageous if the battery has either of these structures. That is to say, if a positive electrode active material with a layer structure is used, charging the positive electrode to 4.30 V or higher will advantageously increase the battery capacity yet simultaneously causes the dissolution of cobalt or other elements. If a positive electrode active material with a spinel structure is used, charging the positive electrode to 4.20 V or higher similarly causes the dissolution of manganese or other elements. In any of these cases, the provision of the inorganic particle layer will prevent the problem associated with the dissolution of the elements and greatly improve the storage characteristics and cycle characteristics at high temperatures.

In the case of using lithium cobalt oxide as the positive electrode active material, it is preferable that aluminum, zirconium or magnesium be added to lithium cobalt oxide or that aluminum, zirconium and magnesium form a solid solution with lithium cobalt oxide, in order to avoid the dissolution of cobalt or other elements.

It is preferable that the thickness of the inorganic particle layer be 1 μm or greater and 4 μm or less, and specifically 1 μm or greater and 2 μm or less.

The reason for these limitations is as follows. Although the aforementioned trapping effect becomes more remarkable as the inorganic particle layer becomes thicker, the layer should not be too thick since thickening the inorganic particle layer increases the internal resistance of the battery and thereby deteriorates its load characteristics. Thickening the layer also decreases the amounts of the active materials of both the positive and negative electrodes and accordingly lowers the energy density of the battery. Simultaneously, the layer should not be too thin to obtain an adequate trapping effect, although thin layers also have the trapping effect to some extent. It should be noted that the thickness of the inorganic particle layer in this specification is the thickness on one side.

The present invention achieves the advantageous effect of enabling a battery to exhibit excellent high-temperature storage characteristics and high-temperature cycle characteristics and operate with high reliability even if a high-capacity battery design is adopted.

### BRIEF DESCRIPTION OF THE DRAWINGS

FIG. 1 is a scanning electron microscope (SEM) image of spherical particles (KR380, manufactured by Titan Kogyo, Ltd.);

FIG. 2 is an SEM image of non-spherical particles (AKP3000, manufactured by the Sumitomo Chemical Co., Ltd.);

FIG. 3 is a graph showing an evaluation result of the dispersion capability of Slurry a2 of the invention;

FIG. 4 is a graph showing an evaluation result of the dispersion capability of Comparative Slurry z2;

FIG. 5 is a graph showing an evaluation result of the dispersion capability of Comparative Slurry z3;

FIG. 6 is a graph showing a relationship between the percentage of atypical alumina particles and the cycle life of the battery;

FIG. 7 is a graph showing a relationship between the percentage of atypical alumina particles and the density of a mixture of titania particles and alumina particles; and

FIG. 8 is a graph showing a relationship between the percentage of atypical alumina particles and the rate of density increase.

### PREFERRED EMBODIMENT OF THE INVENTION

Hereinbelow, the present invention is described in further detail. It should be construed, however, that the present invention is not limited to the following embodiment and examples, but various changes and modifications are possible without departing from the scope of the invention.

### Manufacture of Positive Electrode

Lithium cobalt oxide (in the form of a solid solution containing Al and Mg at 1.0 mol %, respectively, with 0.05 mol % of Zr fixed on the surface) as a positive electrode active material, acetylene black as a carbon conductive agent, and polyvinylidene fluoride (PVDF) as a binder were mixed together at a mass ratio of 95:2.5:2.5 and then agitated with N-methyl-2-pyrrolidinone (NMP) as a solvent, using a COMBI MIX™ mixer of the Primix Corporation, to obtain a slurry mixture for the positive-electrode. Next, this slurry mixture was applied to both sides of an aluminum foil serving as a positive electrode current collector and then subjected to drying and rolling processes to obtain a positive electrode with positive electrode active material layers on both sides of the aluminum foil. The filling density of the positive electrode active material layers was 3.60 g/cc.

### Manufacture of Negative Electrode

A carbon material (artificial graphite), carboxymethyl cellulose (CMC), and styrene-butadiene rubber (SBR) were mixed in an aqueous solution at a mass ratio of 98:1:1 to obtain a slurry mixture for the negative electrode. This slurry mixture was then applied to both sides of a copper foil serving as a negative electrode current conductor and then subjected to drying and rolling processes to form negative electrode active material layers on both sides of the copper foil. The filling density of the negative electrode active material layers was 1.60 g/cc.

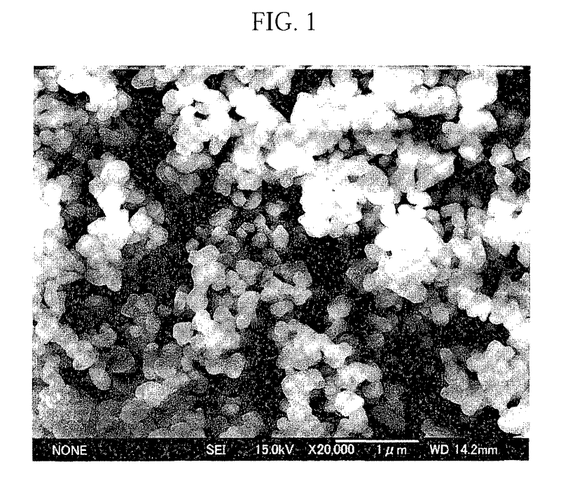

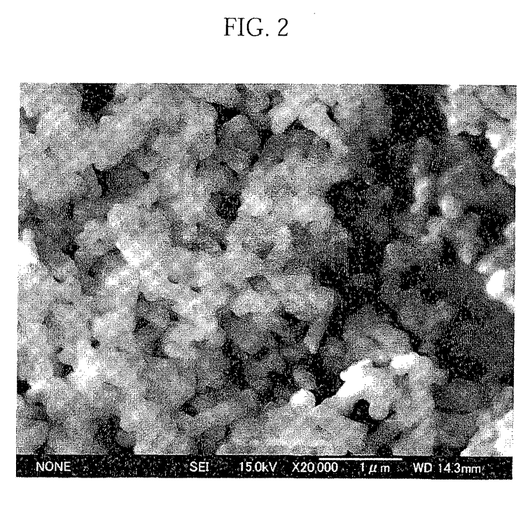

Next, an inorganic particle slurry with inorganic particles dispersed therein was prepared by mixing inorganic particles and a copolymer with an acrylonitrile structure (or structural unit) (polymer with rubber properties) as a binder into NMP as a solvent and then performing a mixing and dispersing process using a FILMICS™ mixer of the Primix Corporation. The inorganic particles consisted of spherical rutile-type titania particles (KR380, manufactured by Titan Kogyo, Ltd.; average particle size, 0.38 μm; tap density, 0.77 g/cc; a photographic image of the particles is shown in FIG. 1) and atypical alumina particles (AKP3000, manufactured by the Sumitomo Chemical Co., Ltd.; average particle size, 0.60 μm; tap density, 0.60 g/cc; a photographic image of the particles is shown in FIG. 2), the two particles being mixed at a mass ratio of 25:75. The non-spherical alumina particles were substantially tetrapod shaped. The proportion of the solid contents (which consisted of the inorganic particles and the binder) to the total amount of the inorganic particle slurry was 35 mass %. The proportion of the binder to the total amount of the inorganic particle was 3 mass %.

Subsequently, the inorganic particle slurry was applied to the entire surface of one negative electrode active material layer by a micro-gravure process, and the solvent was removed by a drying process to obtain an inorganic particle layer on one side of the negative electrode active material layer. Then, another inorganic particle layer was similarly formed on the entire surface of the other negative electrode active material layer. Thus, a negative electrode was created. The total thickness of the two inorganic particle layers was 4 μm (2 μm on each side).

### Preparation of Non-Aqueous Electrolyte

A mixed solvent containing ethylene carbonate (EC) and diethyl carbonate (DEC) at a volume ratio of 3:7 was prepared. Then, LiPF₆ as the main electrolyte was dissolved in that solvent at a concentration of 1.0 mol/L to obtain a non-aqueous electrolyte.

### Assembly of Battery

A lead terminal was attached to each of the positive and negative electrodes. The two electrodes, with a separator made of a micro-porous polyethylene film (average pore size: 0.1 μm) interposed in between, were then spirally wound and laterally pressed to obtain a flat electrode assembly. This assembly was put into the internal space of a battery container made of laminated aluminum films, after which the non-aqueous electrolyte was injected into the internal space. Finally, the laminated aluminum films were fused together to complete the battery. In designing this battery, the amounts of the active materials of the positive and negative electrodes were controlled so that the charge cut-off voltage would be 4.40 V and the capacity ratio of the two electrodes at this voltage (i.e. the ratio of the charge capacity of the negative electrode to that of the positive electrode at the first charging cycle) would be 1.08. The design capacity of the battery was 850 mAh. It should be noted that the present invention does not limit the charge cut-off voltage to 4.40 V; the effect of the invention becomes more remarkable as the charge cut-off voltage increases.

### EXAMPLES

### Example 1

In Example 1, the battery described in the previous embodiment was used.

The battery thus manufactured is hereinafter referred to as Battery A1 of the invention.

### Example 2

A battery was manufactured in the same manner as in Example 1 except that the spherical rutile-type titania particles and the atypical alumina particles, both as the inorganic particles, were mixed together at a mass ratio of 50:50.

The battery thus manufactured is hereinafter referred to as Battery A2 of the invention, and the inorganic particle slurry used in Example 2 is referred to as Slurry a2 of the invention.

### Example 3

A battery was manufactured in the same manner as in Example 1 except that the spherical rutile-type titania particles and the atypical alumina particles, both as the inorganic particles, were mixed together at a mass ratio of 75:25.

The battery thus manufactured is hereinafter referred to as Battery A3 of the invention.

### Comparative Example 1

A battery was manufactured in the same manner as in Example 1 except that no inorganic particle layer was formed on the negative electrode.

The battery thus manufactured is hereinafter referred to as Comparative Battery z1.

### Comparative Example 2

A battery was manufactured in the same manner as in Example 1 except that only the spherical rutile-type titania particles were used as the inorganic particles.

The battery thus manufactured is hereinafter referred to as Comparative Battery Z2, and the inorganic particle slurry used in Comparative Example 2 is referred to as Comparative Slurry z2.

### Comparative Example 3

A battery was manufactured in the same manner as in Example 1 except that only the atypical alumina particles were used as the inorganic particles.

The battery thus manufactured is hereinafter referred to as Comparative Battery Z3, and the inorganic particle slurry used in Comparative Example 3 is referred to as Comparative Slurry z3.

### Comparative Example 4

A battery was manufactured in the same manner as in Example 1 except that only alumina particles were used as the inorganic particles and those alumina particles were spherical alumina particles (AKP50, manufactured by the Sumitomo Chemical Co., Ltd.; average particle size, 0.3 μm; tap density, 1.1 g/cc).

The battery thus manufactured is hereinafter referred to as Comparative Battery Z4, and the inorganic particle slurry used in Comparative Example 4 is referred to as Comparative Slurry z4.

### Experiment 1

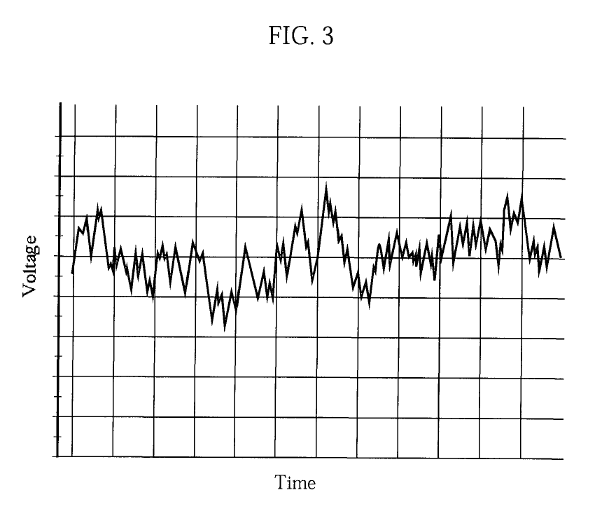

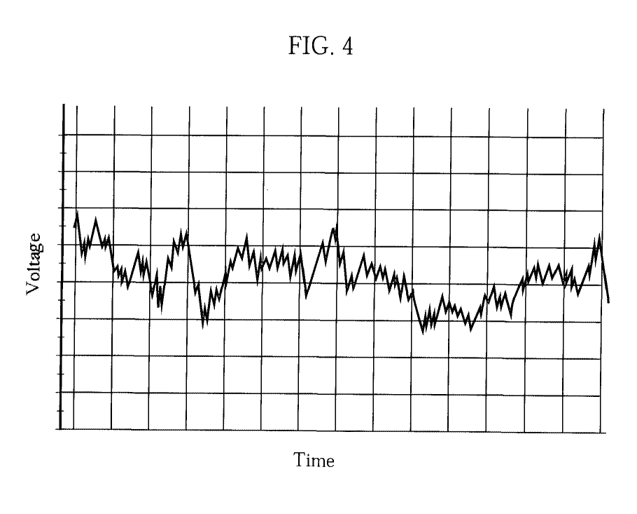

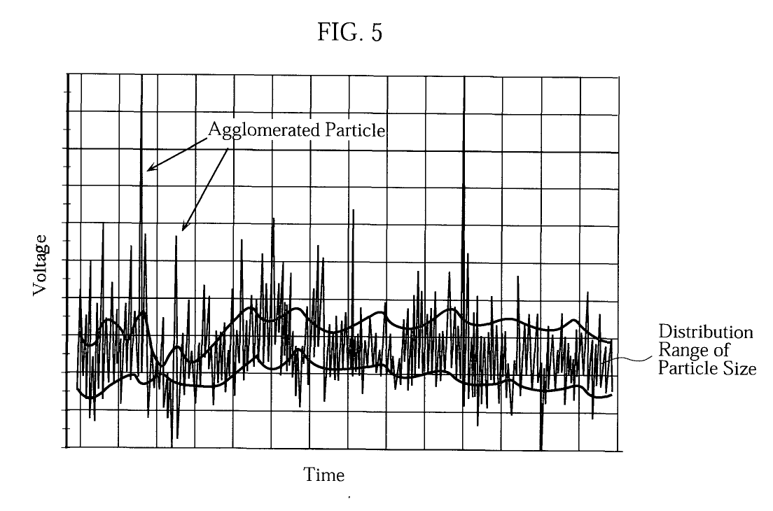

The dispersion capabilities of Slurry a2 of the invention and Comparative Slurries z2 to z4 (i.e. the state of agglomeration and presence of bubbles in each slurry) were evaluated. The result is as shown in FIGS. 3 to 5 and Table 1. FIG. 3 is a graph showing the evaluation result for Slurry a2 of the invention, FIG. 4 is a graph showing the evaluation result for Comparative Slurry z2, and FIG. 5 is a graph showing the evaluation result for Comparative Slurry z3. The evaluation was made using an Appearance Monitor of the Sensor Technology Inc.

An Appearance Monitor is an in-line measurement device that can measure the particle size and concentration of a fluid flowing through a pipe by casting a near-infrared ray into the fluid and detecting the intensity of transmitted and scattered rays of light. Its output level is correlated with the average particle size, and its amplitude with the variation range of the particle size. These pieces of information enable the detection of the agglomeration of inorganic particles or the presence of bubbles in the slurry.

TABLE 1

| | Filler | | | | |
|---|---|---|---|---|---|
| | particles | | | Dispersion | Coating |
| Slurry | (ratio) | Agglomeration | Bubbles | capability | quality |
| a2 | Spherical | Not detected | Not detected | Good | Good |
| | titania/ | | | | |
| | Atypical | | | | |
| | alumina | | | | |
| | (50/50) | | | | |
| z2 | Spherical | Not detected | Not detected | Good | Good |
| | titania | | | | |
| | (100) | | | | |
| z3 | Atypical | Detected | Detected | Poor | Poor |
| | alumina | | | | |
| | (100) | | | | |
| z4 | Spherical | Detected | Detected | Poor | Poor |
| | alumina | | | | |
| | (100) | | | | |

In the case of Comparative Slurry z3 in which atypical alumina particles were used as the inorganic particles, the output signal had large amplitudes, as shown in FIG. 5. This indicates the presence of agglomerated particles and bubbles in the inorganic particle slurry. A possible reason for this is as follows. A process of dispersing fine particles generally applies a shearing force to the particles, and this force pulverizes the fine particles during the dispersing process. If the fine particles used in this process are atypical, the particles will be more easily pulverized by this shearing force. The pulverized fine particles attract each other by gravitation into agglomerated forms if there is no appropriate binder in the inorganic particle slurry.

It is known that, if the dispersion capability of the inorganic particle slurry deteriorates due to the formation of agglomerated particles or bubbles, the uniformity of the inorganic particle layer to be formed onto the negative electrode by applying the slurry significantly will be significantly lowered. As is evident from Table 1, use of a slurry containing only the atypical alumina particles, which are poorly dispersible, deteriorates the coating quality and impedes the creation of an inorganic particle layer with uniform qualities. Such a non-uniform inorganic particle layer lowers the uniformity of the chemical reactions at the electrode and eventually deteriorates the battery characteristics, as will be explained later.

On the other hand, in the case of Comparative Slurry z2 in which spherical titania particles were used as the inorganic particles, neither agglomerated particles nor bubbles were detected, as shown in FIG. 4. The dispersion capability and coating quality were good. However, an observation of a cross section of the resultant organic particle layer showed that the particles were densely packed due to their spherical shape, and there was little void left as compared to the case where the atypical inorganic particles were used. This lack of void in the inorganic particle layer lowers the permeability of the electrolyte and thereby deteriorates the high-temperature cycle characteristics and other properties, as will be explained later.

Though not shown in the drawings, it was also confirmed that agglomerated particles and bubbles were present in Comparative Slurry z4 in which only the spherical alumina particles were used, and the dispersion capability and coating quality were poor. This result proves that titania particles are more preferable than alumina particles in terms of the dispersion capability and coating quality provided that the two kinds of particles are equally spherical.

In the case of Slurry a2 of the present invention in which spherical titania particles and atypical alumina particles were used as the inorganic particles, the inorganic particle slurry was free from agglomerated particles or bubbles, as shown in FIG. 3, and the dispersion capability and coating quality were excellent. This is because Slurry a2 of the invention contains not only atypical alumina particles, which are easy to pulverize, but also spherical titania particles, which are hard to pulverize, so that the slurry can be more quickly dispersed and achieve a higher degree of dispersion than in the case of Comparative Slurry z3, in which only atypical fine particles are used as the inorganic particles and these particles are easy to pulverize and agglomerate, as explained previously. In addition, an observation of a cross section of the inorganic particle layer made of Slurry a2 showed that the void ratio was slightly smaller than in the case where the layer was made of only the atypical alumina. Thus, Slurry a2 of the present invention enables the creation of an inorganic particle layer with an even thickness and uniform qualities.

### Experiment 2

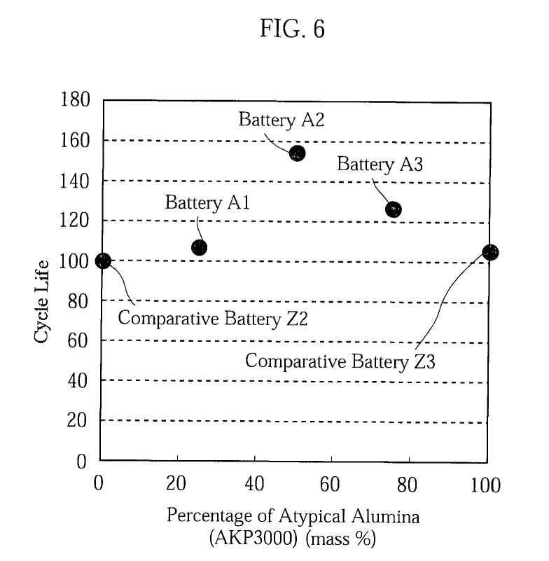

The storage characteristics (the ratio of the remaining capacity after a high-temperature storage) and cycle characteristics (cycle life) of Batteries A1 to A3 of the invention and Comparative Batteries Z1 to Z3 were investigated. The result is as shown in Table 2. Based on this result, the correlation between the percentage of atypical alumina particles and the cycle life was studied. The result is as shown in FIG. 6. The experiment was conducted under the following charge-discharge conditions and storage conditions.

### Charge and Discharge Conditions

The batteries were charged with the current held at 1.0 It (850 mA) until the battery voltage reached 4.4 V, and then discharged with the current held at 1.0 It (850 mA) until the battery voltage declined to 3.0 V.

The interval between the charging and discharging operations was 10 minutes.

### High-Temperature Storage Characteristics

Storage Condition

The batteries were subjected to one cycle of charge-discharge operations under the previously defined conditions, and then recharged to the specified voltage under the aforementioned charging conditions and left at 60° C. for 20 days.

Calculation of Ratio of Remaining Capacity

The batteries were cooled to room temperature and their remaining capacity was measured by discharging them under the same condition as specified previously. Then, using the following equation (1), the ratio of remaining capacity was calculated from the discharged capacity (remaining capacity) at the first discharging operation after the storage test and the discharged capacity before the test.

Ratio of remaining capacity (%)=(DC₁/DC₀)×100 (1)

DC₀: Discharged capacity before the storage test

DC₁: Discharged capacity at the first discharging operation after the storage test

### Charge-Discharge Cycle Characteristics

The charge-discharge operations were repeatedly performed at 45° C. under the aforementioned conditions until the discharged capacity declined to 80% of the level at the first cycle, and the number of the cycles repeated was recorded as the cycle life. In Table 2, the cycle life is represented by an index with a value of 100 representing the cycle life of Comparative Battery Z1.

TABLE 2

| | Presence | | Ratio of | |
|---|---|---|---|---|
| | of inorganic | | Remaining | |
| | particle | Filler particles | capacity | Cycle life |
| Battery | layer | (ratio) | (%) | (cycles) |
| A1 | Yes | Spherical titania/ | 65.3 | 107 |
| | | Atypical alumina | | |
| | | (25/75) | | |
| A2 | | Spherical titania/ | 66.8 | 155 |
| | | Atypical alumina | | |
| | | (50/50) | | |
| A3 | | Spherical titania/ | 66.7 | 127 |
| | | Atypical alumina | | |
| | | (75/25) | | |
| Z1 | No | N/A | 35.2 | 100 |
| Z2 | Yes | Spherical titania | 65.1 | 102 |
| | | (100) | | |
| Z3 | | Atypical alumina | 63.8 | 106 |
| | | (100) | | |

### Discussion on High-Temperature Storage Characteristics

As is evident from Table 2, the high-temperature storage characteristics (i.e. the ratio of the remaining capacity after the high-temperature charge and storage) of Batteries A1 to A3 of the invention and Comparative Batteries Z2 and Z3, all of which have an inorganic particle layer formed on the negative electrode, are better than those of Comparative Battery Z1, which has no inorganic particle layer formed on the negative electrode. A possible reason is as follows. During the high-temperature charge and storage periods, the dissolution of elements from the positive electrode active material and decomposition of the electrolyte take place. In Batteries A1 to A3 and Comparative Batteries Z2 and Z3, the elements dissolved from the positive electrode active material or decomposition products of the electrolyte are trapped by the inorganic particle layer, so that the negative electrode and the separator are less damaged and the high-temperature storage characteristics are improved.

However, the high-temperature storage characteristics of Comparative Battery Z3, in which only atypical alumina particles (non-spherical inorganic particles) were used to create the inorganic particle layer, are lower than those of Comparative Battery Z2, in which only spherical titania particles (spherical inorganic particles) were used to create the inorganic particle layer, or Batteries A1 to A3, in which a mixture of the spherical titania particles and the atypical alumina particles was used to create the inorganic particle layer. A possible reason for this difference is as follows. Comparative Battery Z3, in which only atypical alumina particles were used to create the inorganic particle layer, has too much of a void in the inorganic particle layer, so that the layer cannot adequately show the trapping effect. On the other hand, in Comparative Battery Z2, in which only spherical titania particles were used to create the inorganic particle layer, the proportion of the void in the inorganic particle layer is low, so that the layer can adequately show the trapping effect. This discussion also holds true for Batteries A1 to A3, in which a mixture of the spherical titania particles and the atypical alumina particles was used to create the inorganic particle layer, since these batteries allow the mixture ratio of the spherical titania particles and the atypical alumina particles to be varied so as to appropriately control the proportion of the void in the inorganic particle layer.

### Discussion on Charge-Discharge Cycle Characteristics

As is evident from Table 2, the high-temperature cycle characteristics of Batteries A1 to A3 of the invention, in which a mixture of the spherical titania particles and the atypical alumina particles was used to create the inorganic particle layer, are higher than those of Comparative Battery Z3, in which only atypical alumina particles were used to create the inorganic particle layer, or Comparative Battery Z2, in which only spherical titania particles were used to create the inorganic particle layer. A possible reason is as follows.

The inorganic particle layer on the negative electrode not only provides the previously-explained trapping effect but also improves the cycle characteristics by helping the supply of the electrolyte. In Comparative Battery Z2, in which spherical titania particles were used to create the inorganic particle layer, the inorganic particles in the layer are densely packed due to their spherical shape, as confirmed by a cross-sectional observation of the layer. Thus, the proportion of the void in the inorganic particle layer of Comparative Battery Z2 is low, as already pointed out. This lack of void prevents the inorganic particle layer from sufficiently helping the supply of the electrolyte, so that the electrolyte cannot adequately permeate into the negative electrode, and the cycle characteristics cannot be sufficiently improved.

In Comparative Battery Z3, in which only atypical alumina particles were used to create the inorganic particle layer, there is more of a void in the inorganic particle layer than that in Comparative Battery Z2 in which spherical titania particles were used to create the inorganic particle layer, as confirmed by a cross-sectional observation of the layer. Therefore, the layer can effectively help the supply of electrolyte, so that the electrolyte can adequately permeate into the negative electrode. However, as explained earlier, an inorganic particle layer with plenty of voids inside cannot effectively trap the elements dissolved from the positive electrode or decomposition products of the electrolyte. These phenomena tend to more easily occur at high temperatures. Thus, the cycle characteristics of Comparative Battery Z3 are low. Another reason for this low cycle characteristics relates to the quality of the slurry. That is, the exclusive use of atypical alumina particles to create the inorganic particle layer deteriorates the dispersion capability of the slurry, which makes it difficult to obtain a coating with uniform qualities. This can result in the segregation of a highly-insulating binder or an uneven thickness of the coating. These conditions lead to uneven chemical reactions at the electrode, and hence the deterioration of the cycle characteristics.

On the other hand, in Batteries A1 to A3 of the invention in which a mixture of spherical titania particles and atypical alumina particles was used to create the inorganic particle layer, the void ratio in the inorganic particle layer can be controlled at a desired value so as to simultaneously achieve both effects of helping the supply of electrolyte and trapping the dissolved elements and decomposition products. Furthermore, the inclusion of the spherical titania particles in addition to the atypical alumina particles improves the dispersion capability of the slurry and thereby prevents unfavorable situations such as the segregation of a highly-insulating binder or an uneven thickness of the coating. As a result, the chemical reactions uniformly take place at the electrode, so that the cycle characteristics improves.

As is clear from FIG. 6, it has been confirmed that the cycle characteristics improve when the percentage of the atypical alumina particles is 25 mass % or greater and 99 mass % or less. Particularly, the cycle characteristics drastically improved when the percentage was 40 mass % or greater and 75 mass % or less.

### Experiment 3

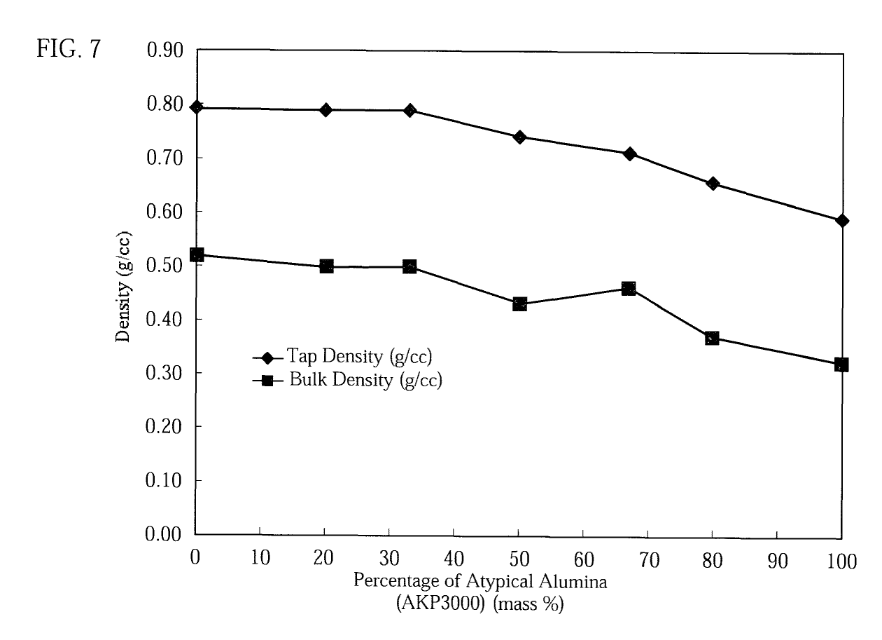

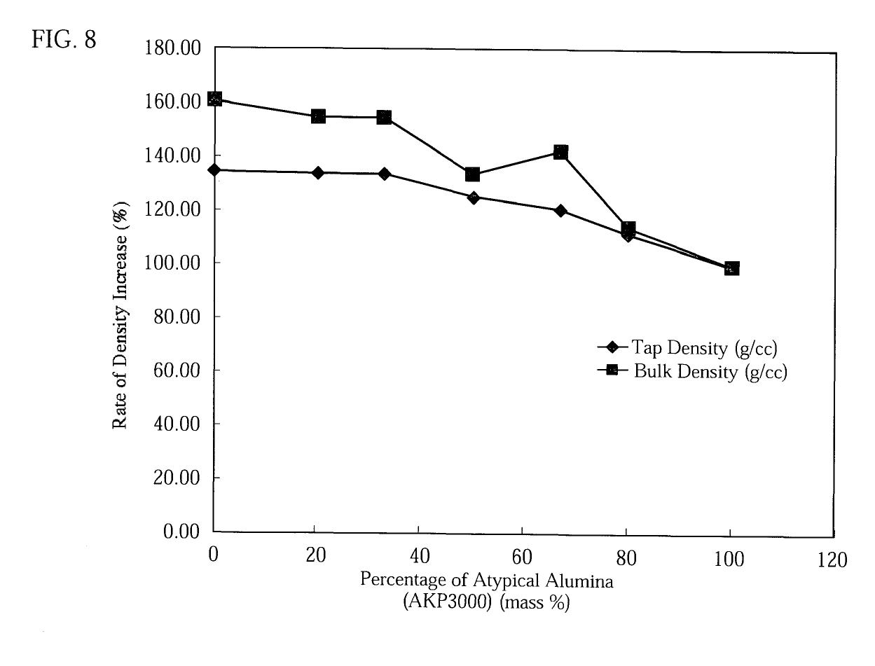

Spherical rutile-type titania particles (KR380, manufactured by Titan Kogyo, Ltd.) and atypical alumina particles (AKP3000, manufactured by the Sumitomo Chemical Co., Ltd.) were mixed to prepare Samples 1 to 7 with various mixture ratios, and the bulk density and tap density of each sample were measured. The result is as shown in Table 3 and FIG. 7. The tap density and bulk density of each sample are also shown in Table 3 and FIG. 8 by a ratio to the value of Sample 1 (with no rutile-type titania particles added), with a value of 100 representing the tap density or bulk density of Sample 1.

TABLE 3

| | | | Volume measured when | | Volume measured when | |
|---|---|---|---|---|---|---|
| | Inorganic particles [amount] | Mass | tap density was | Tap density | bulk density was | Bulk density |
| Sample | (ratio) | (g) | calculated (cc) | and its ratio | calculated (cc) | and its ratio |
| Sample 1 | Al₂O₃ [3 mass %] | 3.01 | 5.1 | 0.59 g/cc | 9.3 | 0.32 g/cc |
| | (100) | | | (100) | | (100) |
| Sample 2 | Al₂O₃ [4 mass %]:TiO₂ [1 mass %] | 3.03 | 4.6 | 0.66 g/cc | 8.2 | 0.37 g/cc |
| | (80:20) | | | (111.58) | | (114.14) |
| Sample 3 | Al₂O₃ [3 mass %]:TiO₂ [1.5 mass %] | 3.00 | 4.2 | 0.71 g/cc | 6.5 | 0.46 g/cc |
| | (67:33) | | | (120.89) | | (142.44) |
| Sample 4 | Al₂O₃ [2 mass %]:TiO₂ [2 mass %] | 3.03 | 4.1 | 0.74 g/cc | 7.0 | 0.43 g/cc |
| | (50:50) | | | (125.24) | | (133.76) |
| Sample 5 | Al₂O₃ [1.5 mass %]:TiO₂ [3 mass %] | 3.00 | 3.8 | 0.79 g/cc | 6.0 | 0.50 g/cc |
| | (33:67) | | | (133.72) | | (154.44) |
| Sample 6 | Al₂O₃ [1 mass %]:TiO₂ [4 mass %] | 3.00 | 3.8 | 0.79 g/cc | 6.0 | 0.50 g/cc |
| | (20:80) | | | (133.73) | | (154.44) |
| Sample 7 | TiO₂ [3 mass %] | 3.02 | 3.8 | 0.79 g/cc | 5.8 | 0.52 g/cc |
| | (100) | | | (134.50) | | (160.69) |

AKP3000 was used as Al₂O₃, and KR380 as TiO₂.

The ratio of the tap density or bulk density is a ratio to the value of Sample 1 (in which only Al₂O₃ particles were used as the inorganic particles), with a value of 100 representing the tap density or bulk density of Sample 1.

As is evident from Table 3 and FIGS. 7 and 8, the tap density of Sample 1, in which only atypical alumina particles (non-spherical inorganic particles) were used, is lower than that of Sample 7, in which only spherical rutile-type titania particles (spherical inorganic particles) were used. Since the real density of alumina substantially equals that of alumina (approx. 3.9 g/cc), the lower tap density indicates a lower percentage of space occupied by the inorganic particles per unit volume (i.e. a larger percentage of void per unit volume). Accordingly, if an inorganic particle layer of Sample 1 (in which only atypical alumina particles are used) is formed on one negative electrode and another inorganic particle layer of Sample 7 (in which only spherical rutile-type titania particles are used) on another negative electrode, the former electrode will have a higher void ratio in the inorganic particle layer than the latter.

The tap densities of Samples 2 to 6, in which the spherical and non-spherical inorganic particles were mixed at different ratios, are all between the tap density of Sample 1 and that of Sample 7. These tap densities can be arbitrarily controlled by changing the mixture ratio of the two kinds of particles. That is, by varying the mixture ratio of the spherical and non-spherical inorganic particles, the void ratio in the inorganic particle layer can be appropriately controlled so that the layer will have both the electrolyte permeation effect and the trapping effect. Particularly, by adding the non-spherical particles mixed by a ratio of 20 mass % or greater, it is possible to satisfactorily control the tap density and the void ratio in the inorganic particle layer so as to achieve an optimal void ratio. Though not evident from Table 4, an investigation conducted by the inventors have demonstrated that the void ratio will be optimized when the tap density is 0.60 g/cc or greater and 0.79 g/cc or less (particularly, 0.65 g/cc or greater and 0.75 g/cc or less).

By such a density control, it is possible to prevent the situation where the tap density is so high that the inorganic particles are densely packed and the void ratio in the inorganic particle layer is too low, and also the situation where the tap density is so low that the inorganic particles are loosely distributed and the void ratio in the inorganic particle layer is too high. The density control can also prevent the problem that too low a tap density causes the inorganic particles to have excessively large particle sizes and thus impede the creation of an inorganic particle layer with a thickness of a few micrometers. Inorganic particles having a low tap density can be produced by various methods, e.g. by sintering the inorganic particles.

The bulk densities and tap densities of elliptical magnesia particles (500-04R, manufactured by Kyowa Chemical Industry Co., Ltd.) and spherical alumina particles (AKP50, manufactured by the Sumitomo Chemical Co., Ltd.), as well as those of the aforementioned spherical rutile-type titania particles (KR380, manufactured by Titan Kogyo, Ltd.) and atypical alumina particles (AKP3000, manufactured by the Sumitomo Chemical Co., Ltd.), were investigated. The result is as shown in Table 4. As shown in this table, the tap densities of the elliptical magnesia particles and spherical alumina particles were 0.48 g/cc and 1.12 g/cc, respectively. Both of these particles can be used as the inorganic particle of the present invention.

TABLE 4

| | | | Volume measured when tap | | Volume measured when | |
|---|---|---|---|---|---|---|
| Inorganic particles | | Mass | density was calculated | Tap density | bulk density was calculated | Bulk density |
| (Product code) | Shape | (g) | (cc) | (g/cc) | (cc) | (g/cc) |
| Al₂O₃ | Spherical | 3.02 | 2.7 | 1.12 | 3.5 | 0.86 |
| (AKP50) | | | | | | |
| TiO₂ | | 3.01 | 3.9 | 0.77 | 5.5 | 0.55 |
| (KR380) | | | | | | |
| Al₂O₃ | Atypical | 3.07 | 5.1 | 0.60 | 8.2 | 0.37 |
| (AKP3000) | | | | | | |
| MgO | Elliptical | 3.01 | 6.3 | 0.48 | 10.4 | 0.29 |
| (500-04R) | | | | | | |

### Other Embodiments

(1) Although the inorganic particle layer was formed on the surface of negative electrode active material layer in the previous embodiment, it is naturally possible to provide the inorganic particle layer on the surface of positive electrode active material layer.

(2) The performance of the non-aqueous electrolyte battery can be further enhanced by changing the mixture ratio of the spherical or substantially spherical inorganic particles and the non-spherical inorganic particles according to the charge voltage of the battery or other factors. For example, if the charge voltage is high, there will be a larger amount of dissolved elements or decomposition products. Accordingly, it is preferable to increase the proportion of the spherical or substantially spherical inorganic particles in order to lower the void ratio in the inorganic particle layer and thereby improve the trapping effect.

(3) The void ratio in the inorganic particle layer can be controlled not only by mixing spherical inorganic particles and non-spherical inorganic particles, but also by mixing spherical inorganic particles of different particle sizes. However, this method is problematic in that the use of large-sized particles in addition to the small-sized ones inevitably causes the inorganic particle layer to be thicker.

(4) The binder used in the inorganic particle layer is not limited to any specific binder. However, in order to adequately exhibit the effects of the present invention, it is desirable that the binder:

(I) can provide an adequate binding strength to withstand the manufacturing process of the battery;

(II) can fill the gaps between the inorganic particles even after the layer has swelled due to the absorption of the electrolyte;

(III) can ensure the dispersibility of the inorganic particles (or be capable of preventing re-agglomeration); and

(IV) will be scarcely dissolved in the electrolyte.

Examples of binders with such capabilities and properties include polytetrafluoroethylene (PTFE), polyvinylidene fluoride (PVDF), polyacrylonitrile (PAN), styrene-butadiene rubber (SBR), compounds modified or derived from any of these materials, copolymers containing an acrylonitrile unit, and polyacrylic acid derivatives. Copolymers containing an acrylonitrile unit are particularly preferable since they satisfy the conditions (I) and (III) even by a small additive quantity and have the excellent effects of improving the dispersion capability of the slurry and giving flexibility to the electrode.

(5) Examples of the solvent for preparing an inorganic particle slurry include, but not limited to, acetone, cyclohexane, water and the like in addition to the aforementioned NMP. Preferable methods for dispersing the inorganic particles in the slurry include wet dispersion methods using a bead mill or roll mill in addition to the previously explained method using the FILMICS™ mixer. A slurry containing such small inorganic particles as used in the present invention should be subjected to a mechanical dispersion process; otherwise, the slurry will suffer severe sedimentation and prevent the creation of a film with uniform qualities. Accordingly, it is preferable to employ a dispersion method used for dispersing coating compounds in the paint industry.

Examples of the method for applying the inorganic particles on the negative electrode include die coating, dip coating, curtain coating, spray coating and the like in addition to the aforementioned micro-gravure coating, and gravure coating and die coating are particularly preferable. One reason is because the application work should be intermittently performed to prevent the energy density from decreasing as a result of applying some particles to extra (unnecessary) portions of the electrode. Another reason is the necessity of accurately controlling the coating thickness (thin-film coating). Furthermore, it is preferable to adopt a method capable of speedy application and quick drying of the slurry to prevent a decrease in the adhesion strength due to diffusion of the solvent or binder into the negative electrode active material layer (a decrease in the adhesion strength between the negative electrode active material layer and the inorganic particle layer due to dissolution of a negative electrode binder, or an increase in the resistance of the plate electrode due to penetration of the binder into the inorganic particle layer), and other problems. The solid content concentration of the inorganic particle slurry significantly varies depending on the coating method. In the case of spray coating, dip coating or curtain coating, the solid content concentration should be low, preferably 3 to 30 mass %, since it is difficult to mechanically control the coating thickness by these techniques. In the case of die coating, gravure coating or similar technique, the concentration may be higher, preferably 5 to 70 mass %.

(6) The solvent of the electrolyte used in the present invention is not limited to any specific solvent. An example is a mixture of cyclic carbonate (e.g. ethylene carbonate, propylene carbonate or butylene carbonate) and chain carbonate (e.g. dimethyl carbonate, methyl ethyl carbonate, diethyl carbonate). A mixture of cyclic carbonate and an ether solvent (e.g. 1,2-dimethoxyethane or 1,2-diethoxyethane) is also usable.

Examples of the solute in the electrolyte include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, Li₂B₁₂Cl₁₂, and a mixture of two or more of these compounds. A particularly preferable example is a mixture of LiXF_{y} (where X is selected from P, As, Sb, B, Bi, Al, Ga and In; y=6 if X is P, As or Sb, or y=4 if X is B, Bi, Al, Ga or In) and either lithium perfluoroalkyl sulfonic acid imide LiN(CₘF₂ₘ₊₁SO₂)(CₙF₂ₙ₊₁SO₂) (where m and n are each an integer from 1 to 4) or lithium perfluoroalkyl sulfonic acid methide LiN(CₚF₂ₚ₊₁SO₂)(C_{q}F_{2q+1}SO₂)(CᵣF₂ᵣ₊₁SO₂) (where p, q and r are each an integer from 1 to 4). Among these compounds, a mixture of LiPF₆ and LiN(C₂F₅SO₂)₂ is particularly preferable. Although the electrolyte concentration is not specifically limited, it is preferable that the concentration is 1.0 to 1.8 mol per one liter of electrolyte.

Other examples of the electrolyte include gel polymer electrolytes consisting of a polymer electrolyte (e.g. polyethylene oxide or polyacrylonitrile) permeated with an electrolyte solution, and inorganic solid electrolytes such as LiI or Li₃N. In a lithium secondary battery of the present invention, any electrolyte can be used without limitations as long as the lithium compound as the solute for providing the ion-conductivity and a solvent for dissolving and retaining the lithium compound do not decompose during the charge or discharge process of the battery or due to the voltage applied while the battery is stored.

(7) The positive electrode active material is not limited to lithium cobalt oxide. Other usable materials include lithium composite oxides containing cobalt or manganese, such as lithium cobalt-nickel-manganese composite oxide, lithium aluminum-nickel-manganese composite oxide, and lithium aluminum-nickel-cobalt composite oxide. Spinel-type lithium manganese oxides are also available. Preferably, the positive electrode active material is a layer-structured material and its capacity becomes higher than a specific capacity at a lithium reference electrode potential of 4.3 V when charged at a higher voltage. Each positive electrode active material may be independently used or mixed with other positive electrode active materials. In the case of using lithium cobalt oxide, it is preferable to add Zr, Mg or Al.

(8) The method for preparing a positive electrode mixture is not limited to wet mixing methods. For example, it may include dry mixing a positive electrode active material and a conductive agent beforehand, then mixing them with PVDF and NMP, and stirring.

(9) The negative electrode active material is not limited to artificial graphite; any kind of material is usable as far as it is capable of intercalation and de-intercalation of lithium ions. Examples include graphite, coke, tin oxide, metallic lithium, silicon, and mixtures of these materials.

The present invention can be suitably applied to the power sources of mobile phones, notebook computers, PDAs and other mobile information devices, and particularly to those applications in which high capacity is required. The application area is expected to expand to high-power applications that require the battery to continuously operate at high temperatures, including hybrid electric vehicles and electric tools whose batteries are subjected to severe operation environments.

What is claimed is:

1. A non-aqueous electrolyte battery including:
a positive electrode;
a negative electrode;
a separator located between the positive and negative electrodes;
a non-aqueous electrolyte; and
an inorganic particle layer being located on a surface of at least one of the positive and negative electrodes, the inorganic particle layer containing inorganic particles and a binder,
wherein the inorganic particles include spherical or substantially spherical inorganic particles and non-spherical inorganic particles.

2. The non-aqueous electrolyte battery according to claim 1, wherein the inorganic particle layer is located on the surface of the negative electrode.

3. The non-aqueous electrolyte battery according to claim 1, wherein the non-spherical inorganic particles have at least one shape selected from the group consisting of rod-like shapes, scaly shapes, atypical shapes, fibrous shapes and polygonal shapes.

4. The non-aqueous electrolyte battery according to claim 2, wherein the non-spherical inorganic particles have at least one shape selected from the group consisting of rod-like shapes, scaly shapes, atypical shapes, fibrous shapes and polygonal shapes.

5. The non-aqueous electrolyte battery according to claim 3, wherein a shape of the non-spherical inorganic particles is atypical.

6. The non-aqueous electrolyte battery according to claim 4, wherein a shape of the non-spherical inorganic particles is atypical.

7. The non-aqueous electrolyte battery according to claim 5, wherein a proportion of the atypical inorganic particles to a total amount of the inorganic particles is 25 mass % or greater and 99 mass % or less.

8. The non-aqueous electrolyte battery according to claim 6, wherein a proportion of the atypical inorganic particles to a total amount of the inorganic particles is 25 mass % or greater and 99 mass % or less.

9. The non-aqueous electrolyte battery according to claim 7, wherein the proportion of the atypical inorganic particles to the total amount of the inorganic particles is 40 mass % or greater and 75 mass % or less.

10. The non-aqueous electrolyte battery according to claim 8, wherein the proportion of the atypical inorganic particles to the total amount of the inorganic particles is 40 mass % or greater and 75 mass % or less.

11. The non-aqueous electrolyte battery according to claim 1, wherein the inorganic particles are made of rutile-type titania or alumina.

12. The non-aqueous electrolyte battery according to claim 5, wherein the atypical inorganic particles are made of alumina and the spherical inorganic particles are made of rutile-type titania.

13. The non-aqueous electrolyte battery according to claim 6, wherein the atypical inorganic particles are made of alumina and the spherical inorganic particles are made of rutile-type titania.

14. The non-aqueous electrolyte battery according to claim 1, wherein a proportion of the binder to the inorganic particles is 30 mass % or less.

15. The non-aqueous electrolyte battery according to claim 1, wherein an average particle size of the inorganic particles is larger than an average pore size of the separator.

16. The non-aqueous electrolyte battery according to claim 1, wherein:
a positive electrode active material of the positive electrode has a layer structure; and
the potential of the positive electrode at the end of charge is 4.30 V or higher relative to the potential of a lithium reference electrode.

17. The non-aqueous electrolyte battery according to claim 2, wherein:
a positive electrode active material of the positive electrode has a layer structure;
and
the potential of the positive electrode at the end of charge is 4.30 V or higher relative to the potential of a lithium reference electrode.

18. The non-aqueous electrolyte battery according to claim 1, wherein:
a positive electrode active material of the positive electrode has a spinel structure; and
the potential of the positive electrode at the end of charge is 4.20 V or higher relative to the potential of a lithium reference electrode.

19. The non-aqueous electrolyte battery according to claim 2, wherein:
a positive electrode active material of the positive electrode has a spinel structure; and
the potential of the positive electrode at the end of charge is 4.20 V or higher relative to the potential of a lithium reference electrode.

20. The non-aqueous electrolyte battery according to claim 1, wherein a thickness of the inorganic particle layer is 1 μm or greater and 4 μm or less.
